(19) United States
(12) Patent Application Publication
(10) Pub. No.: US 2025/0053357 A1
(43) Pub. Date: Feb. 13, 2025

(54) PRINTING APPARATUS, MOBILE DEVICE, PRINTING MANAGEMENT SERVER, AND CONTROL METHOD THEREFOR

(71) Applicant: CANON KABUSHIKI KAISHA, Tokyo (JP)

(72) Inventor: KENTA YABE, Kanagawa (JP)

(21) Appl. No.: 18/789,946

(22) Filed: Jul. 31, 2024

(30) Foreign Application Priority Data
Aug. 9, 2023 (JP) 2023-130531

(51) Int. Cl. G06F 3/12

(52) U.S. Cl. CPC G06F 3/1237; G06F 3/1205; G06F 3/1285

(57) ABSTRACT

A printing apparatus reads a two-dimensional code including an encoded completion condition for the printing apparatus to satisfy in order to complete printing processing according to a print job stored in a printing management server and an encoded identifier of the print job, obtains behavior settings specifying a behavior of the printing apparatus for a case where it is determined that the printing apparatus does not satisfy the completion condition, and executes a behavior specified by the behavior settings in a case where it is determined that the printing apparatus does not satisfy the completion condition.

### BACKGROUND OF THE INVENTION

### Field of the Invention

The present invention relates to a printing apparatus, a mobile device, a printing management server, and a control method therefor.

### Description of the Related Art

A known technique (Japanese Patent Laid-Open No. 2015-111365) obtains data to be printed from a cloud service on the basis of information embedded in a two-dimensional code read by a printing apparatus. URL information storing print data is encoded in such a two-dimensional code. A user can make a printing apparatus start printing processing by only reading a two-dimensional code with the printing apparatus. It is not guaranteed that the printing apparatus can complete the printing processing for the obtained print data on the basis of the information read from the two-dimensional code. For example, the printing apparatus presented with the two-dimensional code may not include a function necessary for the printing processing of the print data or may not include the necessary amount of a consumable.

### SUMMARY OF THE INVENTION

An aspect of the present disclosure includes enabling a printing apparatus that has read a two-dimensional code to execute appropriate behavior.

According to an embodiment, a printing apparatus comprising: a reading unit that reads a two-dimensional code including an encoded completion condition for the printing apparatus to satisfy in order to complete printing processing according to a print job stored in a printing management server and an encoded identifier of the print job; a settings obtaining unit that obtains behavior settings specifying a behavior of the printing apparatus for a case where it is determined that the printing apparatus does not satisfy the completion condition; and an executing unit that executes a behavior specified by the behavior settings in a case where it is determined that the printing apparatus does not satisfy the completion condition is provided.

Further features of the present invention will become apparent from the following description of exemplary embodiments with reference to the attached drawings.

### BRIEF DESCRIPTION OF THE DRAWINGS

FIG. 1 is a block diagram for describing an example of the configuration of a printing system according to a first embodiment.

FIGS. 2A and 2B are block diagrams for describing an example of the hardware configuration of the printing system according to the first embodiment.

FIG. 3 is a block diagram for describing an example of the software configuration of the printing system according to the first embodiment.

FIGS. 4A and 4B are schematic diagrams for describing examples of screens of a mobile device according to the first embodiment.

FIG. 5 is a sequence diagram for describing an example of operations of registration processing of a printing apparatus according to the first embodiment.

FIG. 6 is a sequence diagram for describing an example of operations of two-dimensional code issuing processing according to the first embodiment.

FIGS. 7A and 7B are sequence diagrams for describing an example of operations of printing processing according to the first embodiment.

FIG. 8 is a diagram for describing information encoded in a two-dimensional code according to the first embodiment.

FIG. 9 is a flow diagram for describing an example of operations for determining a behavior at time of insufficiency according to the first embodiment.

FIG. 10 is a schematic diagram for describing an example of a confirmation dialog according to the first embodiment.

FIG. 11 is a flow diagram for describing an example of operations for determining behavior settings according to a second embodiment.

FIG. 12 is a sequence diagram for describing an example of operations for determining behavior settings according to a third embodiment.

FIG. 13 is a flow diagram for describing an example of operations for determining behavior settings according to the third embodiment.

FIG. 14 is a sequence diagram for describing an example of operations for displaying a screen according to the third embodiment.

FIG. 15 is a schematic diagram for describing examples of screens of a mobile device according to the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

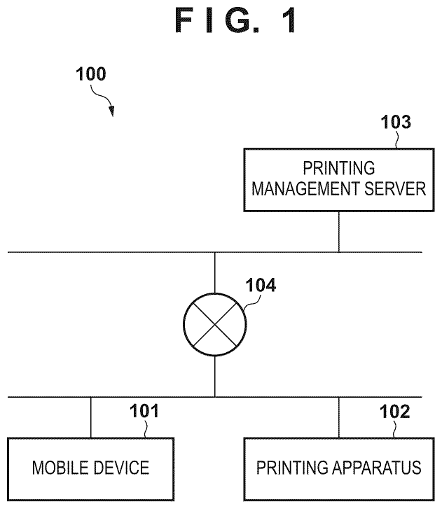

An example of the configuration of a printing system 100 according to the first embodiment will be described with reference to FIG. 1. The printing system 100 may include a mobile device 101, a printing apparatus 102, and a printing management server 103. In the example of FIG. 1, the printing system 100 is illustrated as including one of each of these components. However, the printing system 100 may include a plurality of these components.

The mobile device 101 is a device that uses a printing service provided by the printing management server 103. For example, the mobile device 101 may be a smartphone or a tablet. The mobile device 101 uses a web browser application or a dedicated printing management application to transmit document data corresponding to the print target to the printing management server 103. The mobile device 101 obtains a two-dimensional code from the printing management server 103 as the response. The two-dimensional code may be a QR code (registered trademark), for example.

The printing apparatus 102 is a printing apparatus including a function for connecting to a network 104 and a function for reading two-dimensional codes. The printing apparatus 102 may be a multi-function peripheral (MFP) including a print function as a main function and other functions (for example, a scan function and a copy function). Alternatively, the printing apparatus 102 may be a single-function peripheral including only a print function as a main function. The printing apparatus 102 may be a printing apparatus (in other words, a 2D printer) that prints onto sheet-like media or may be a printing apparatus that forms a three-dimensional structure (in other words, a 3D printer). In the example described below, the printing apparatus 102 is an MFP.

The printing management server 103 converts a printing instruction received from the mobile device 101 to a two-dimensional code and responses to the mobile device 101 with the two-dimensional code. Also, the printing management server 103 transmits print data to an apparatus that transmitted a request including a two-dimensional code (for example, the printing apparatus 102 that read the two-dimensional code).

The mobile device 101, the printing apparatus 102, and the printing management server 103 can communicate with one another via the network 104. The network 104 may be configured as any one of, for example, a local area network (LAN), a wide area network (WAN), a telephone line, a dedicated digital line, an ATM, a frame relay line, a cable television line, a wireless line for data broadcast, or the like. For example, the network 104 may include the Internet.

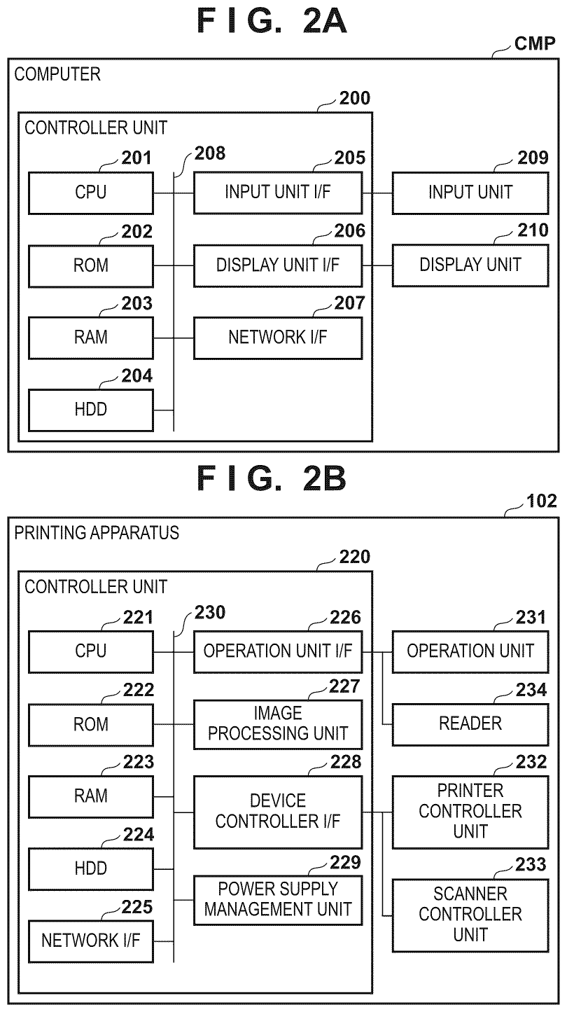

An example of the hardware configuration of a computer CMP will now be described with reference to FIG. 2A. The computer CMP can be used as the mobile device 101 and the printing management server 103. Hereinafter, a component (for example, a controller unit 200) of the computer CMP used as the mobile device 101 is referred to simply as a component of the mobile device 101 (for example, the controller unit 200 of the mobile device 101). The same applies to the printing management server 103.

The computer CMP may include the components illustrated in FIG. 2A. The computer CMP may include components not illustrated in FIG. 2A and may not include one or more of the components illustrated in FIG. 2A. One or more of the components illustrated in FIG. 2A may be implemented as virtual hardware via virtual technology. The computer CMP includes the controller unit 200, an input unit 209, and a display unit 210. In FIG. 2A, the computer CMP is illustrated as including the input unit 209 and the display unit 210, but the input unit 209 and the display unit 210 may be devices external to the computer CMP.

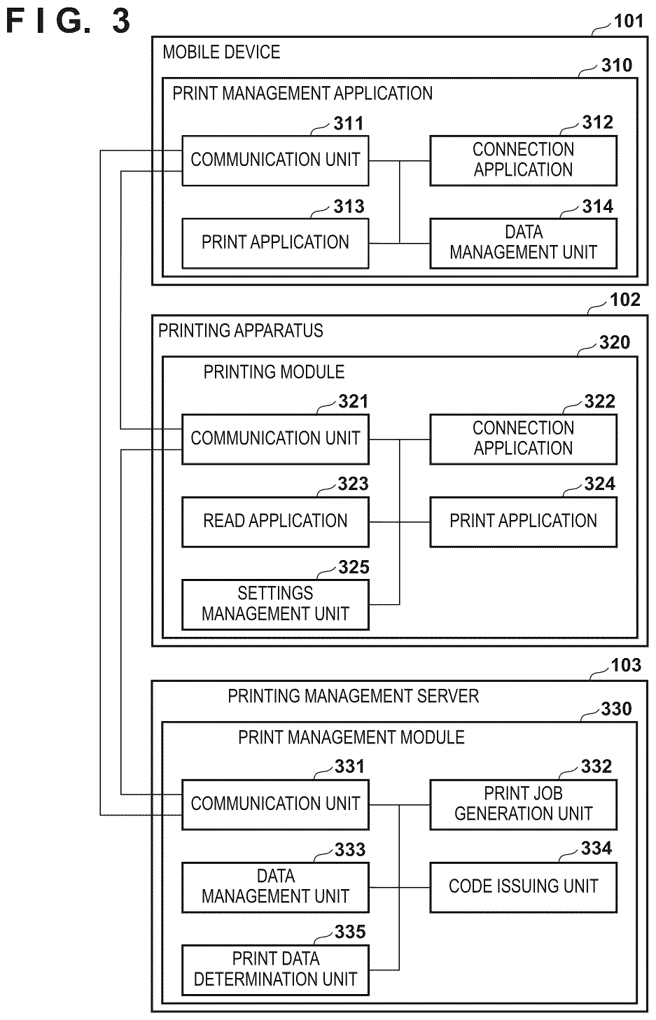

A central processing unit (CPU) 201 controls the overall operations of the computer CMP. For example, the CPU 201 executes a boot program stored in a read-only memory (ROM) 202 to run an operating system (OS). Also, the CPU 201 executes an application program stored in a hard disk drive (HDD) 204 on the OS to execute various types of processing. The application program described using FIG. 3 may also be stored in the HDD 204.

A random-access memory (RAM) 203 is used as the work area of the CPU 201. The HDD 204 stores the application program described above and data (for example, settings, history information, and the like) used in the processing by the CPU 201. The ROM 202, the RAM 203, an input unit interface (I/F) 205, a display unit I/F 206, and a network I/F 207 are connected to the CPU 201 via a system bus 208.

The input unit I/F 205 is an interface with the input unit 209. The input unit 209 is configured of a mouse, a keyboard, and the like. The input unit IF 205 transmits information input by a user using the input unit 209 to the CPU 201. The display unit I/F 206 outputs image data to be displayed by the display unit 210 to the display unit 210. The display unit 210 is configured of a display and the like. The input unit 209 and the display unit 210 may be integrally formed as a touch screen. The network I/F 207 is connected to the network 104 and communicates with other apparatuses (for example, the printing apparatus 102) via the network 104.

An example of the hardware configuration of the printing apparatus 102 will be described with reference to FIG. 2B. The printing apparatus 102 may include the components illustrated in FIG. 2B. The printing apparatus 102 may include components not illustrated in FIG. 2B and may not include one or more of the components illustrated in FIG. 2B.

The CPU 221 controls the overall operations of the printing apparatus 102. For example, the CPU 221 executes a boot program stored in a ROM 222 to run an OS. Also, the CPU 221 executes an application program stored in an HDD 224 on the OS to execute various types of processing.

A RAM 223 is used as the work area of the CPU 221. The HDD 224 stores the application program described above and data (for example, settings, history information, and the like) used in the processing by the CPU 221. The ROM 222, the RAM 223, a network I/F 225, an operation unit I/F 226, an image processing unit 227, a device controller I/F 228, and a power supply management unit 229 are connected to the CPU 221 via a system bus 230.

The network I/F 225 is connected to the network 104 and communicates with other apparatuses (for example, the mobile device 101) via the network 104. The operation unit I/F 226 is an interface with an operation unit 231 and a reader 234. The operation unit 231 is configured of a touch screen and the like. The operation unit I/F 226 transmits information input by a user using the operation unit 231 to the CPU 221. Also, the operation unit I/F 226 outputs image data to be displayed by the operation unit 231 to the operation unit 231. The reader 234 executes two-dimensional code reading processing and decoding processing. The reader 234 reads information by decoding the read two-dimensional code and transmits this information to the CPU 221.

A printer controller unit 232 and a scanner controller unit 233 are connected to the device controller I/F 228. The device controller I/F 228 may perform synchronous/non-synchronous transformations of the image data. The printer controller unit 232 controls the printer device. The scanner controller unit 233 controls the scanner device.

The image processing unit 227 executes processing including output processing of images to a printer device, input processing of images from a scanner device, image rotation, image compression, resolution conversion, color space conversion, tone conversion, and the like. The power supply management unit 229 controls the overall power supply of the printing apparatus 102. For example, the power supply management unit 229 may turn the power on and off, transition to a power saving state, return to a normal state, and the like.

An example of the software configuration of the components of the printing system 100 will be described with reference to FIG. 3. The software configuration components included in the mobile device 101 may be implemented by the CPU 201 executing a program stored in a storage device (for example, the ROM 202, RAM 203, or the HDD 204) of the mobile device 101. Alternatively, at least one or more of the software configuration components included in the mobile device 101 may be implemented by a dedicated integrated circuit such as an application specific integrated circuit (ASIC). The same applies to the printing apparatus 102 and the printing management server 103. Each component of the printing system 100 may include components not illustrated in FIG. 3 and may not include one or more of the components illustrated in FIG. 3. For example, the printing apparatus 102 may further include software configuration components for implementing a scan function and a print function.

The mobile device 101 includes a print management application 310. The print management application 310 is an application including a function for transmitting an issue code request. The issue code request may be a request for a two-dimensional code to be issued. The issue code request may be referred to as a two-dimensional issue code request. A communication unit 311 transmits an issue code request to the printing management server 103 via the network 104. Also, the communication unit 311 communicates with the printing apparatus 102 via the network 104.

A connection application 312 connects to a connection application 322 of the printing apparatus 102 via the network 104. The connection application 312 can connect to the connection application 322 only in a case where the mobile device 101 and the printing apparatus 102 are connected to the same network (same LAN). In a case where the connection application 312 and the connection application 322 are connected, the mobile device 101 may be able to obtain printer information from the printing apparatus 102 and directly (in other words, bypassing the printing management server 103) transmit a print request to a print application 324 of the printing apparatus 102.

A print application 313 transmits an issue code request to the printing management server 103 via the network 104. The issue code request may include print target data, print settings for this data, and behavior settings described below. The print target data may be document data, image data, and the like managed by a data management unit 314. In response to receiving an issue code request from the print application 313, the printing management server 103 converts the print target data included in the issue code request into print data of a format that is printable by the printing apparatus 102. Thereafter, the printing management server 103 sends a two-dimensional code embedded with URL information representing the storage location of the converted print data back to the print application 313. The processing relating to the print application 313 and the two-dimensional code according to the present embodiment will be described below in detail.

The data management unit 314 manages printable data stored on the HDD 204 of the mobile device 101. Specifically, the data management unit 314 manages document data and image data such as photos so that they can be referenced from the print application 313. Also, the data management unit 314 may store the two-dimensional code received from the printing management server 103.

The printing apparatus 102 includes a printing module 320. The printing module 320 is a software module in the printing apparatus 102 including a function for transmitting print requests. A communication unit 321 transmits a print request to the printing management server 103 via the network 104. Also, the communication unit 321 communicates with the mobile device 101 via the network 104.

The connection application 322 connects to a connection application 312 of the mobile device 101 via the network 104. The connection application 322 can connect to the connection application 312 only in a case where the mobile device 101 and the printing apparatus 102 are connected to the same network (same LAN).

A read application 323 is an application that decodes the two-dimensional code read by the reader 234. The print application 324, in accordance with the information decoded by the read application 323, sends a print request to the printing management server 103 and performs print control and behavior control for the print data received as response. The present processing is described below in detail. A settings management unit 325 manages various types of setting values, remaining amounts of consumables, and the like of the printing apparatus 102. The print application 324 executes print control processing by referencing information managed by the settings management unit 325.

The printing management server 103 includes a print management module 330. The print management module 330 is a software module in the printing management server 103 including a function for executing code issuing processing and printing processing. The code issuing processing may be processing to issue a two-dimensional code. The code issuing processing may be referred to as two-dimensional code issuing processing.

A communication unit 331 receives an issue code request from the mobile device 101 via the network 104. Also, the communication unit 331 receives a print request from the printing apparatus 102 that read the two-dimensional code. A print job generation unit 332 generates print job data on the basis of the print request. The print job data is stored in a print job table managed by a data management unit 333. Also, the data management unit 333 stores the print settings and behavior settings included in the issue code request in association with the print job data stored in the print job table.

A code issuing unit 334 issues a two-dimensional code on the basis of data including an identifier that uniquely identifies print job data managed by the data management unit 333. In response to the printing management server 103 receiving a print request, a print data determination unit 335 determines whether or not the print request can be normally processed. This determination processing is described below in detail.

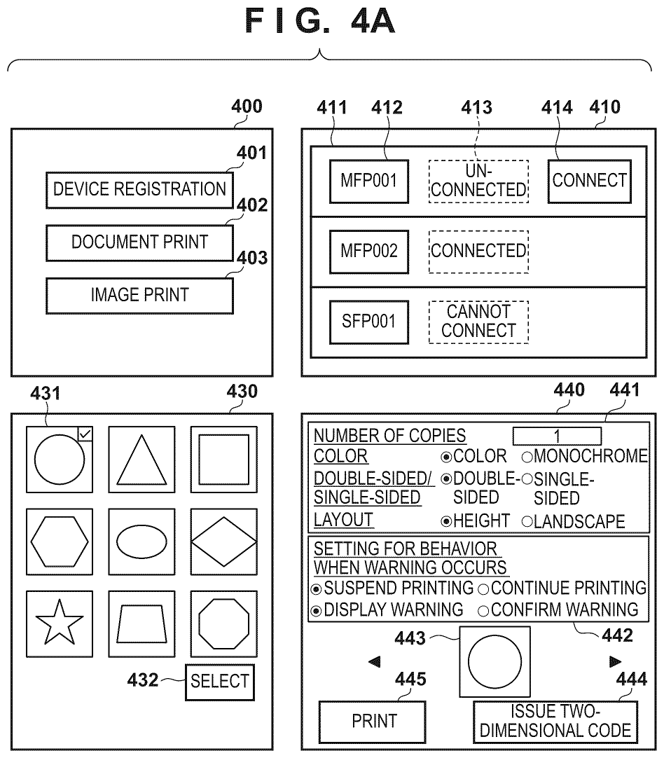

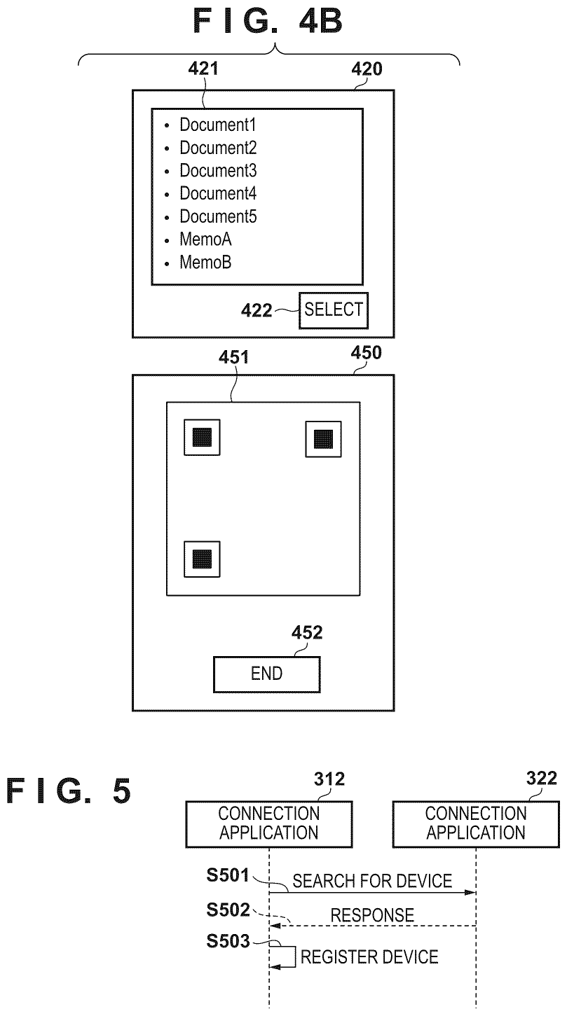

An example of a screen displayed on the display unit 210 of the mobile device 101 that is generated by the print management application 310 of the mobile device 101 will now be described with reference to FIGS. 4A and 4B. The input unit 209 of the mobile device 101 can obtain a user instruction with respect to the image displayed by the display unit 210.

An initial screen 400 is a screen initially displayed in response to the print management application 310 being started up. The initial screen 400 may include a device registration menu button 401, a document print menu button 402, and an image print menu button 403. In response to a user pressing the device registration menu button 401, the print management application 310 switches from the initial screen 400 to a device registration screen 410.

The device registration screen 410 is a screen indicating the connection status with the printing apparatus 102. The device registration screen 410 includes a device list 411 representing one or more printing apparatuses 102 that the mobile device 101 can communicate with at the point in time when the device registration screen 410 is displayed. In a case where the mobile device 101 cannot communicate with any printing apparatus 102, a message indicating this may be displayed instead of the device list 411.

The device list 411 includes a device name label 412, a device status label 413, and a connection button 414. The device name label 412 is a label for displaying a name for identify the printing apparatus 102 that can communicate with the mobile device 101. The device status label 413 is a label for displaying the communication status between the mobile device 101 and the printing apparatus 102.

The connection button 414 is a button for starting processing for registering a specific printing apparatus 102 included in the device list 411. Hereinafter, the processing for registering a specific printing apparatus 102 is referred to as registration processing. In response to a user pressing the connection button 414, the print management application 310 starts the registration processing of the printing apparatus 102 represented by the device name label 412 associated with the connection button 414.

The display contents of the device status label 413 and whether or not the connection button 414 is displayed changes depending on the status of the registration processing between the mobile device 101 and the printing apparatus 102. Regarding the printing apparatus 102 which has previously executed registration processing, “Connected” is indicated in the device status label 413 and the connection button 414 is not displayed. Regarding the printing apparatus 102 which has not previously executed registration processing, “Unconnected” is indicated in the device status label 413 and the connection button 414 is displayed. In a case where the mobile device 101 and the printing apparatus 102 cannot communicate for some reason, regardless of the previous registration processing status, “Cannot connect” is indicated in the device status label 413 and the connection button 414 is not displayed.

An example of the operation of the printing system 100 when the mobile device 101 executes the registration processing will now be described with reference to FIG. 5. The operation of FIG. 5 may be started in response to a user pressing the device registration menu button 401 of the initial screen 400. In S501, the connection application 312 of the mobile device 101 transmits (for example, broadcasts) a communication request for a search for the printing apparatus 102 to the network 104 via the communication unit 311.

In S502, in response to receiving the communication request from the mobile device 101, the connection application 322 of the printing apparatus 102 transmits device information for connecting to it to the mobile device 101 via the communication unit 321. The device information may include the Internet Protocol (IP) address of the printing apparatus 102. The device information may include a device name indicating the name of the printing apparatus 102. The print management application 310 of the mobile device 101 generates the device list 411 on the basis of the device information received from the one or more printing apparatuses 102 and displays the device registration screen 410 including the device list 411.

In S503, in response to a user pressing the connection button 414, the data management unit 314 of the mobile device 101 stores the device information of the printing apparatus 102 designated by the user in the device table. Table 1 below is an example of a device table managed by the data management unit 314.

TABLE 1

| Device | | Communication |
|---|---|---|
| name | IP address | status |
| MFP002 | 192.168.0.11 | OK |
| SFP001 | 192.168.0.6 | NG |

The “Device name” column stores the names of the printing apparatuses 102 connected to the mobile device 101. In a case where the device information received in S502 includes a device name, the data management unit 314 stores the device name in the “Device name” column. The “IP address” column stores the IP addresses of the printing apparatuses 102 connected to the mobile device 101. The “Communication status” column stores the latest communication status between the mobile device 101 and the printing apparatus 102. The data management unit 314 periodically communicates with each of the printing apparatuses 102 managed via the device table and updates the values in the “Communication status” column.

The description of examples of screens displayed by the print management application 310 will be continued with reference again to FIGS. 4A and 4B. In response to a user pressing the document print menu button 402 of the initial screen 400, the print management application 310 switches from the initial screen 400 to a document selection screen 420. The document selection screen 420 includes a document list 421 and a select button 422. The document list 421 is a list indicating the document names of one or more pieces of document data stored in the HDD 204 of the mobile device 101. In response to a user pressing the select button 422 with one or more of the document names selected from the document list 421, the print management application 310 switches from the document selection screen 420 to a print settings screen 440.

In response to a user pressing the image print menu button 403 of the initial screen 400, the print management application 310 switches from the initial screen 400 to an image selection screen 430. The image selection screen 430 includes an image list 431 and a select button 432. The image list 431 is a list indicating thumbnail images of the one or more pieces of image data stored in the HDD 204 of the mobile device 101. In response to a user pressing the select button 432 with one or more of the thumbnail images selected from the image list 431, the print management application 310 switches from the image selection screen 430 to the print settings screen 440.

The print settings screen 440 is a screen for obtaining a designation of print settings from a user. The print settings screen 440 includes a print settings portion 441, a behavior settings portion 442, a print preview portion 443, an issue two-dimensional code button 444, and a print button 445. The print settings portion 441 includes graphic object for designating the print settings of the document data or image data selected on the document selection screen 420 or the image selection screen 430. The items of the print settings may include, for example, number of copies to print, color/monochrome setting, double-sided, single-sided setting, sheet orientation, and the like.

The behavior settings portion 442 includes a graphic object for, in the printing processing described below, designating the behavior of the printing apparatus 102 for which it is determined that the printing processing as set by the user cannot be completed due to an insufficient remaining amount of a consumable of the printing apparatus 102 or the printing apparatus 102 having insufficient capabilities. Hereinafter, the behavior to be taken by the printing apparatus 102 in a case where it is determined that the printing processing as set by the user cannot be completed is referred to as behavior at time of insufficiency.

The behavior at time of insufficiency may be selectable from “Suspend printing”, “Continue printing”, “Display warning”, “Confirm warning”, and the like. For example, in a case where “Suspend printing” is selected, the printing apparatus 102 immediately suspends the printing processing at the point in time when it is determined that the printing apparatus 102 cannot complete the printing as set by the user. In a case where “Continue printing” is selected, the printing apparatus 102 continues the printing processing even if it is determined that the printing apparatus 102 cannot complete the printing as set by the user. In a case where “Display warning” is selected, when it is determined that the printing apparatus 102 cannot complete the printing as set by the user, this is displayed by the mobile device 101 or the printing apparatus 102 and the printing processing is suspended. In a case where “Confirm warning” is selected, when it is determined that the printing apparatus 102 cannot complete the printing as set by the user, this is displayed on the mobile device 101 or the printing apparatus 102. Also, the printing apparatus 102 displays a dialog for asking the user whether or not they will continue the printing processing on the mobile device 101 or the printing apparatus 102 and continues or suspends the printing processing according to the user instruction.

The print preview portion 443 displays a preview image for a case where the document data or image data selected on the document selection screen 420 or the image selection screen 430 is to be printed with the settings designated in the print settings portion 441. In response to a user pressing the issue two-dimensional code button 444, the print application 313 transmits an issue code request to the printing management server 103. In response to receiving a two-dimensional code from the printing management server 103, the print management application 310 switches from the print settings screen 440 to a two-dimensional code display screen 450.

The print button 445 may be able to be pressed only in a case where there is the printing apparatus 102 that the mobile device 101 can communicate with and is already registered in the mobile device 101. In response to a user pressing the print button 445, the print management application 310 switches from the print settings screen 440 to the device registration screen 410. In response to a user pressing the device name label 412 associated with one of the connected printing apparatuses 102, the print application 313 transmits the print data and print settings of the printing apparatus 102 to the print application 324 and starts the printing processing.

The two-dimensional code display screen 450 includes a two-dimensional code display portion 451 and an end button 452. The two-dimensional code display portion 451 is a region for displaying the two-dimensional code received from the printing management server 103. The printing processing may be started by causing the reader 234 of the printing apparatus 102 to read the two-dimensional code displayed on the two-dimensional code display portion 451. In response to a user pressing the end button 452, the print management application 310 switches from the print settings screen 440 to the initial screen 400 and the processing described above repeats.

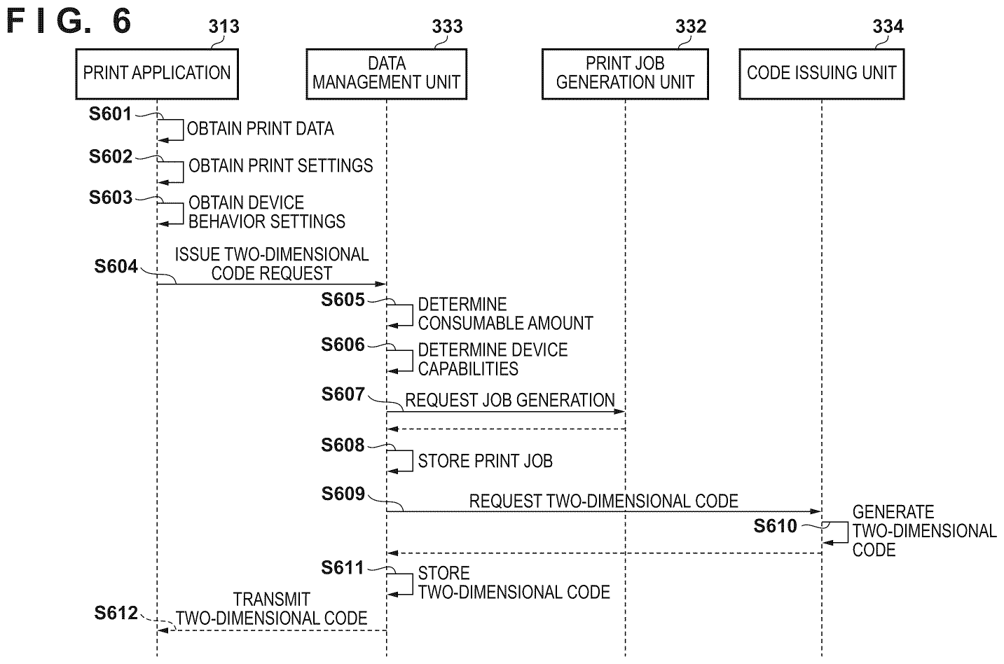

An example of the operation of the mobile device 101 obtaining the two-dimensional code from the printing management server 103 will be described with reference to FIG. 6. The operation of FIG. 6 may be started in response to the initial screen 400 being displayed. In S601, the print application 313 of the mobile device 101 obtains print data from the data management unit 314. The print data may be document data or image data designated as the print target by the user on the document selection screen 420 or the image selection screen 430.

In S602, the print application 313 obtains the print settings for the print data from the user (performs settings obtainment). The print settings may be settings designated in the print settings portion 441 of the print settings screen 440. In S603, the print application 313 obtains the behavior settings for the printing processing of the print data from the user. The behavior settings are settings that specify the behavior at time of insufficiency (in other words, the behavior of the printing apparatus 102 in a case where it is determined that the printing as set by the user cannot be completed). The behavior settings may be settings set in the behavior settings portion 442 of the print settings screen 440. In the example of FIG. 6, the print data, the print settings, and the behavior settings are obtained in this order, but these may be obtained in a different order, or one or more of these may be simultaneously obtained.

In S604, the print application 313 transmits an issue code request to the data management unit 333 of the printing management server 103. This step may be executed in response to a user pressing the issue two-dimensional code button 444 of the print settings screen 440. The issue code request may include the print target data obtained in S601, the print settings obtained in S602, and the behavior settings obtained in S603. Table 2 below indicates an example of the data structure of the issue code request.

TABLE 2

| Mobile | | | |
|---|---|---|---|
| Identifier | Print data | Print settings | Behavior settings |
| MOB001 | [Binary | {“print_setting”: | {“behavior_at_warning”: |
| | data] | {“number_of_copies”:1, | “Continue printing”} |
| | | “color_mode”:”color”, | |
| | | “sides”:”oneside”, | |
| | | “layout”:”vertical”}} | |

The “Mobile identifier” column stores an identifier for uniquely identifying the mobile device 101 that transmitted the issue code request. The identifier of the mobile device 101 may be the serial number of the mobile device 101 or a different identifier. The identifier of the mobile device 101 may be any identifier that allows the printing management server 103 to uniquely identify the mobile device 101. The “Print data” column stores the print data in a binary format.

The “Print settings” column stores the print settings (for example, the setting value for each of the one or more setting items) obtained in S602. The “Behavior settings” column stores the behavior settings obtained in S603. In the example of Table 2, the print settings and the behavior settings are represented by the JavaScript Object Notation (JSON) format. Alternatively, a different format may be used to represent the print settings and the behavior settings.

In S605 and S606, the data management unit 333 of the printing management server 103 determines the condition the printing apparatus 102 should satisfy for completing the printing processing. Hereinafter, this condition is referred to as a completion condition. The completion condition, for example, may include at least one of a condition relating to the amount of a consumable necessary to complete the printing processing and a condition relating to a necessary function to complete the printing processing. Alternatively or additionally, the completion condition may include another condition. An example in which the completion condition includes both the condition relating to the necessary consumable amount and the condition relating to a necessary function will be described below.

In S605, the data management unit 333 of the printing management server 103 calculates the amount of a consumable necessary for the printing apparatus 102 to print the print data on the basis of the print data and print settings stored in the issue code request received from the print application 313. For example, the data management unit 333 may calculate the number of sheets to be consumed by printing the print data on the basis of the page number of the print data, the number of copies to print, and the double-sided/single-sided setting value. Alternatively or additionally, the data management unit 333 may calculate the toner amount to be consumed for each color on the basis of the print data and the color printing setting value.

In S606, the data management unit 333 of the printing management server 103 identifies a function necessary for the printing apparatus 102 to print the print data on the basis of the print data and print settings stored in the issue code request received from the print application 313. For example, in a case where double-sided printing is set in the print settings, a double-sided printing function is identified as a necessary function. In the example of FIG. 6, S606 is executed after S605. This step may be executed in the reverse order or in parallel.

In S607, the data management unit 333 sends the print data and the print settings stored in to the issue code request to the print job generation unit 332 and requests that a print job be generated. The print job generation unit 332 generates a print job according to the request from the data management unit 333 and sends the print job to the data management unit 333.

In S608, the data management unit 333 stores the print job received from the print job generation unit 332 in a print job management table in association with the completion condition (for example, the necessary consumable amount calculated in S605 and the necessary function identified in S606). The print job management table is stored in a storage apparatus (for example, either the RAM 223 or the HDD 224) of the printing management server 103, for example. Table 3 below is an example of a print job management table managed by the data management unit 314.

TABLE 3

| Job | Print | Necessary | | Mobile |
|---|---|---|---|---|
| identifier | job data | consumable amount | Necessary function | identifier |
| 1b252337 | [Binary | “necessary_consum | “necessary_function”: | MOB001 |
| -5e36 | data] | ables”: { | { | |
| -4704 | | “paper”: { | “color”, | |
| -ba21 | | “sheets”: 10, | “2sides_printing”} | |
| - | | “size”: “a4” | | |
| 41ee4edb0 | | }, | | |
| 54d | | “toner”: { | | |
| | | “yellow”: 500, | | |
| | | “magenta”: 100, | | |
| | | “cyan”: 30, | | |
| | | “black”: 800 | | |
| | | } | | |
| | | } | | |

The “Job identifier” column stores an identifier issued by the print job generation unit 332 for uniquely identifying a print job. This identifier is generated when a request is received in S607 by the print job generation unit 332, for example. The “Print job data” column stores the print job generated by the print job generation unit 332 in a binary format. The “Necessary consumable amount” column stores the amount of a consumable necessary for the printing apparatus 102 to print the print data calculated in S605. The “Necessary function” column stores information indicating a function necessary for the printing apparatus 102 to print the print data identified in S606. The “Mobile identifier” column stores the identifier included in the “Mobile identifier” column of the issue code request. In the example of Table 3, the necessary consumable amount and the necessary function are represented by the JavaScript Object Notation (JSON) format. Alternatively, a different format may be used for the necessary consumable amount and the necessary function.

In S609, the data management unit 333 sends the print settings and the behavior settings included in the issue code request received in S604 and the completion condition (for example, the necessary consumable amount determined in S605 and the information of the necessary function identified in S606) to the code issuing unit 334 and requests that a two-dimensional code be generated. In S610, the code issuing unit 334 generates a two-dimensional code representing the information received from the data management unit 333 in S609 and sends this two-dimensional code to the data management unit 333.

In S611, the data management unit 333 stores the job identifier of the print job obtained as a response to the request of S607 and the two-dimensional code obtained as a response to the request of S609 associated together in the two-dimensional code management table. The two-dimensional code management table is stored in a storage apparatus (for example, either the RAM 223 or the HDD 224) of the printing management server 103, for example. Table 4 below is an example of a two-dimensional code management table managed by the data management unit 314.

TABLE 4

| Job identifier | Barcode |
|---|---|
| 1b252337 | [Binary data] |
| -5e36 | |
| -4704 | |
| -ba21 | |
| -41ee4edb054d | |

The “Job identifier” column stores an identifier issued by the print job generation unit 332 for uniquely identifying the print job obtained as a response to the request of S607. The “Two-dimensional code” column stores the two-dimensional code obtained as a response to the request of S609 in a binary format.

In S612, the data management unit 333 transmits the two-dimensional code obtained as a response to the request of S609 to the print application 313. This two-dimensional code is transmitted as a response to the issue code request received in S604.

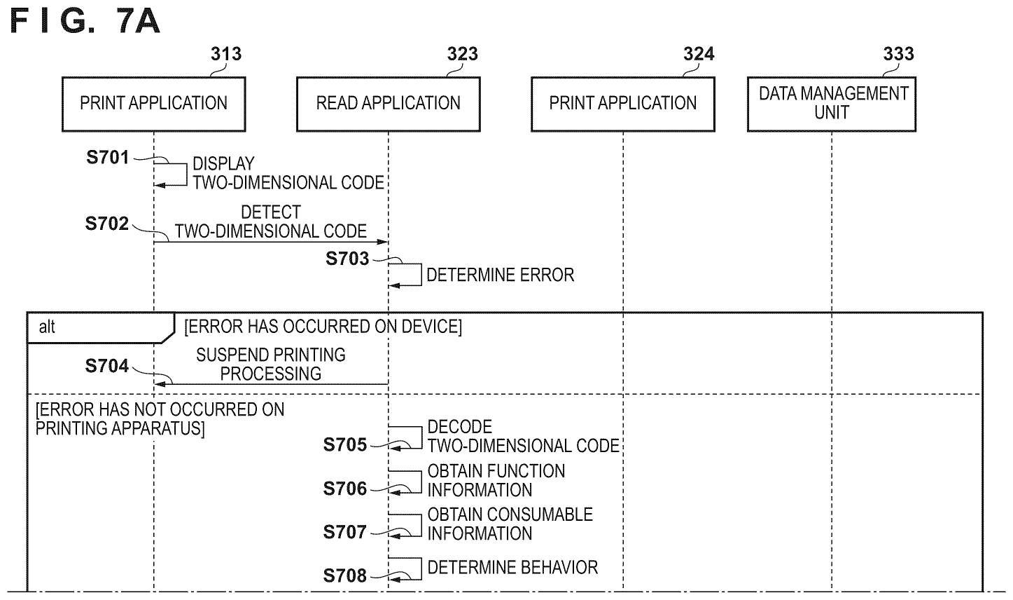

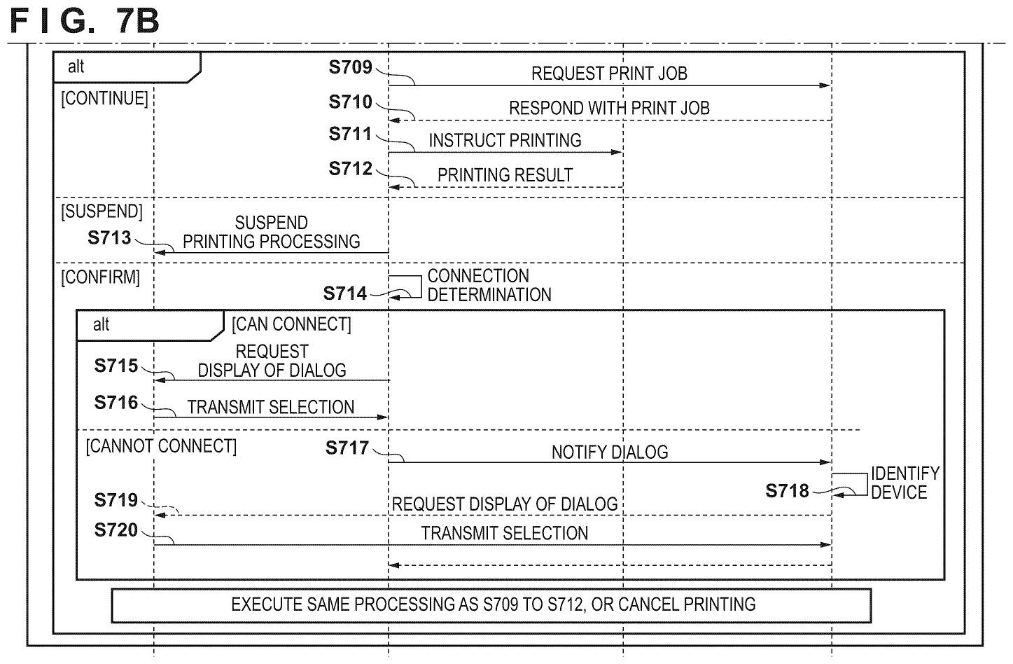

An example of the operation for cause the printing apparatus 102 to execute the printing processing using the two-dimensional code displayed by the mobile device 101 will now be described with reference to FIGS. 7A and 7B. The operation of FIGS. 7A and 7B may be started in response to the two-dimensional code being received by the mobile device 101 from the printing management server 103 in S612 of FIG. 6. In S701, the print application 313 of the mobile device 101 displays the two-dimensional code display screen 450 including the two-dimensional code received from the printing management server 103.

In S702, the read application 323 of the printing apparatus 102 detects that the two-dimensional code has been presented to the reader 234 of the printing apparatus 102. In S703, the read application 323 determines whether or not an error has occurred in the printing apparatus 102. An error may be that the printing apparatus 102 is in a state in which the printing processing is unable to be normally completed. For example, an error may include the printing apparatus 102 being physically unable to be used due to a malfunction in the printing apparatus 102 or may include the remaining amount of a consumable being low or unusable.

In a case where it is determined that an error has occurred in the printing apparatus 102 in S703, the processing transitions to S704. In S704, the read application 323 suspends the printing processing and notifies the user that the printing processing has been suspended. This notification may be performed using the operation unit 231 of the printing apparatus 102 or using the display unit 210 of the mobile device 101. In this manner, in a case where an error occurs in the printing apparatus 102 when reading the two-dimensional code, the read application 323 suspends the printing processing.

In a case where it is determined that an error has not occurred in S703, the processing transitions to S705. In S705, the read application 323 reads the two-dimensional code detected in S702 and decodes the two-dimensional code to read the information from the two-dimensional code.

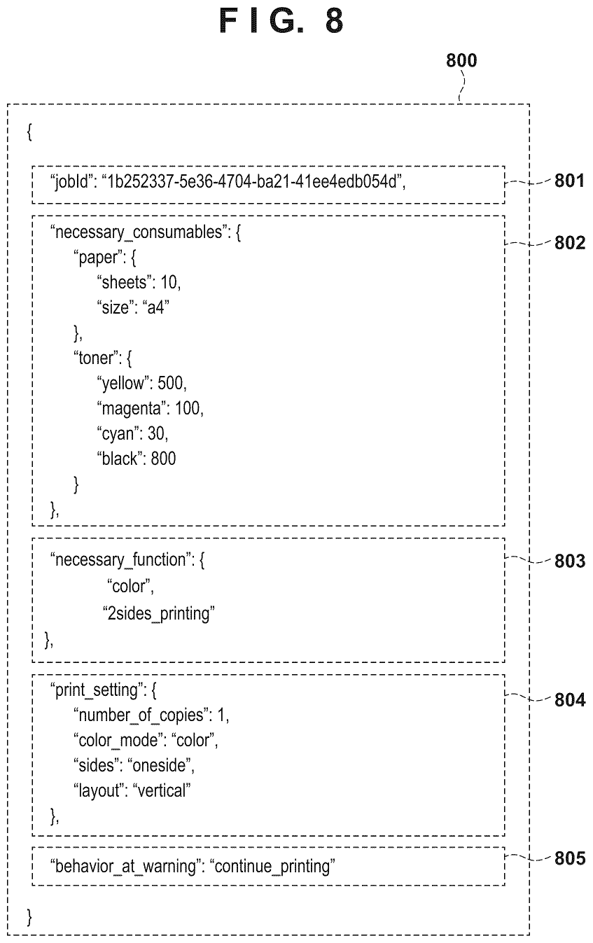

An example of information 800 read from the two-dimensional code by the read application 323 will now be described with reference to FIG. 8. The information 800 includes information used when the printing apparatus 102 executes the printing processing. For example, the information 800 may include a job identifier 801, a necessary consumable amount 802, a necessary function 803, print settings 804, and behavior settings 805. In the example of FIG. 8, the information 800 is represented using the JSON format. Alternatively, a different format may be used to represent the information 800.

The job identifier 801 represents an identifier issued by the print job generation unit 332 for uniquely identifying a print job. The necessary consumable amount 802 represents the amount of a consumable necessary for the printing apparatus 102 to print the print data. The necessary function 803 represents the function necessary for the printing apparatus 102 to print the print data. In this manner, the information 800 includes the necessary consumable amount 802 and the necessary function 803 as completion conditions. The print settings 804 represents the settings relating to the printing processing designated in the print settings portion 441 by the user. The behavior settings 805 represent settings of the behavior of the printing apparatus 102 in a case where it is determined that the printing as set by the user cannot be completed.

The operation of the printing system 100 will now be continued with reference again to FIG. 7A. In S706, the read application 323 obtains function information of the apparatus from a function information table managed by the settings management unit 325. The function information may be a part of the device information of the printing apparatus 102. The function information table is stored in a storage apparatus (for example, either the ROM 222 or the HDD 224) of the printing apparatus 102 when the printing apparatus 102 is manufactured or when the configuration is changed, for example. Table 5 below is an example of a function information table managed by the settings management unit 325.

TABLE 5

| | | Double- | | |
|---|---|---|---|---|
| Device | | sided/Single- | | |
| name | Color/Monochrome | sided | . . . | Sheet size |
| MFP001 | Color | Double- | . . . | A4, A3, B4, |
| | | sided | | B3 |

The function information table includes a “Device name” column and one or more function columns corresponding to one or more functions. The number of function columns may be different for each printing apparatus 102. The function information table indicated in Table 5 includes, as the one or more function columns, a “Color/monochrome” column, a “Double-sided/single-sided” column, and a “Paper size” column.

The “Device name” column stores the name set in the printing apparatus 102. The “Color/monochrome” column stores the color information supported by the printing apparatus 102. For example, in a case where the printing apparatus 102 supports both full color printing and monochrome printing, “Color” is stored, and in a case where the printing apparatus 102 supports only monochrome printing, “Monochrome” is stored. The “Double-sided/single-sided” column stores the information of the sheet sides supported by the printing apparatus 102. For example, in a case where the printing apparatus 102 supports both double-sided printing and single-sided printing, “Double-sided” is stored, and in a case where the printing apparatus 102 supports only single-sided printing, “Single-sided” is stored. The “Sheet size” column stores the sheet sizes supported by the printing apparatus 102.

The operation of the printing system 100 will now be continued with reference again to FIG. 7A. In S707, the read application 323 obtains consumable information of the apparatus from a consumable information table managed by the settings management unit 325. The consumable information may be a part of the device information of the printing apparatus 102. The consumable information table is stored in a storage apparatus (for example, either the ROM 222 or the HDD 224) of the printing apparatus 102. The settings management unit 325 may update the information of the consumable information table by calculating the remaining amount of a consumable each time printing is executed. Table 6 below is an example of a consumable information table managed by the settings management unit 325.

TABLE 6

| Toner: | Toner: | Toner: | Toner: | Sheet: | Sheet: |
|---|---|---|---|---|---|
| Yellow | Magenta | Cyan | Black | A4 | A3 |
| 100% | 90% | 80% | 50% | 1000 | 500 |

The consumable information table includes one or more consumable columns corresponding to one or more consumables. The number of consumable columns may be different for each printing apparatus 102. The “Toner” column stores the remaining amount of toner of each color loaded in the printing apparatus 102. The “Sheet” column stores the remaining number of sheets of each size loaded in the printing apparatus 102.

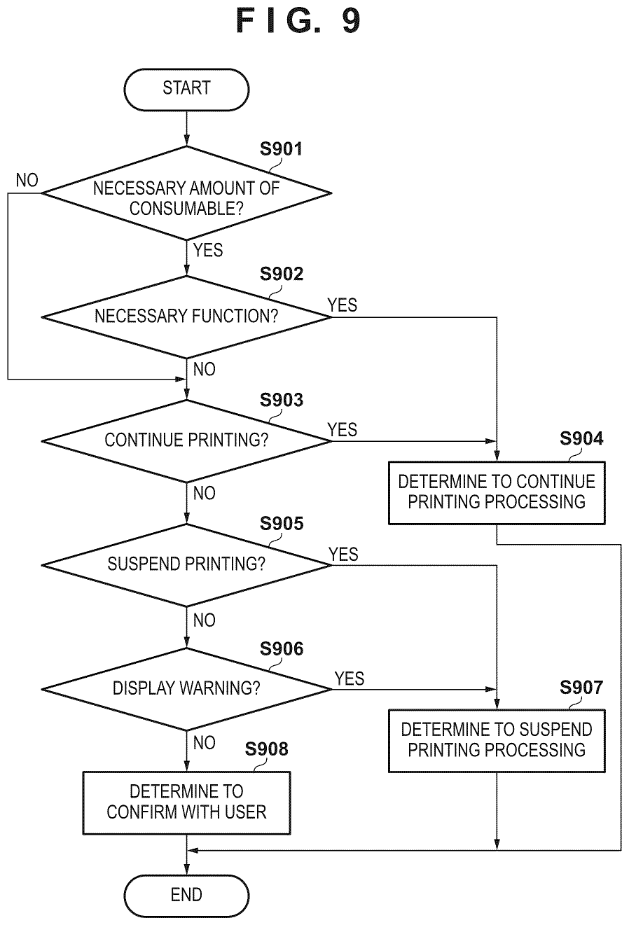

In S708, the read application 323 determines the behavior to be performed by the printing apparatus 102 on the basis of the information of the two-dimensional code read in S705. The processing of S708 will now be described in detail with reference to FIG. 9. In S901, the read application 323 compares the necessary consumable amount 802 included in the information 800 represented by the two-dimensional code and the consumable information obtained in S707 to determine whether or not there is the necessary amount of a consumable remaining for the printing apparatus 102 to perform printing according to the print job. In a case where it is determined that there is the necessary amount of a consumable remaining (“YES” in S901), the processing transitions to S902. Otherwise (“NO” in S901), the processing transitions to S903.

In S902, the read application 323 compares the necessary function 803 included in the information 800 represented by the two-dimensional code and the function information obtained in S706 to determine whether or not there is the necessary function for the printing apparatus 102 to perform printing according to the print job. In a case where it is determined that there is the necessary function (“YES” in S902), the processing transitions to S904. Otherwise (“NO” in S902), the processing transitions to S903. In the example of FIG. 9, S902 is executed after S901. However, these steps may be executed in reverse order.

In a case where there is the necessary amount of a consumable remaining for the printing apparatus 102 and the printing apparatus 102 includes the necessary function (in other words, in a case where it is determined that the printing apparatus 102 satisfies the completion condition), in S904, the read application 323 determines to continue the printing processing. In a case where there is not the necessary amount of a consumable remaining for the printing apparatus 102 or the printing apparatus 102 does not include the necessary function (in other words, in a case where it is determined that the printing apparatus 102 does not satisfy the completion condition), the read application 323 determines the behavior according to the behavior settings 805 included in the information 800 represented by the two-dimensional code.

In S903, the read application 323 determines whether or not “Continue printing” is specified in the behavior settings 805 included in the information 800 represented by the two-dimensional code. In a case where it is determined that “Continue printing” is specified (“YES” in S903), the processing transitions to S904. Otherwise (“NO” in S903), the processing transitions to S905. In a case where it is determined that “Continue printing” is specified, even if it is determined that there is not the necessary amount of a consumable remaining for the printing apparatus 102 or the printing apparatus 102 does not include the necessary function, in S904, the read application 323 determines to continue the printing processing.

In S905, the read application 323 determines whether or not “Suspend printing” is specified in the behavior settings 805 included in the information 800 represented by the two-dimensional code. In a case where it is determined that “Suspend printing” is specified (“YES” in S905), the processing transitions to S907. Otherwise (“NO” in S905), the processing transitions to S906. In S907, the read application 323 determines to suspend the printing processing.

In S906, the read application 323 determines whether or not “Display warning” is specified in the behavior settings 805 included in the information 800 represented by the two-dimensional code. In a case where it is determined that “Display warning” is specified (“YES” in S906), the processing transitions to S907. Otherwise (“NO” in S906), the processing transitions to S908. In S907, the read application 323 determines to suspend the printing processing.

In a case where it is not determined that “Display warning” is specified in S907, this means that “Confirm warning” is specified in the behavior settings 805 included in the information 800 represented by the two-dimensional code. Here, in S908, the read application 323 determines to confirm with the user whether or not to continue the printing processing. The determinations of S903, S905, and S906 may be performed in any order. In a case where these steps are performed in the reverse order of the order in FIG. 9, instead of any one of S903, S905, and S906, whether or not “Confirm warning” is specified in the behavior settings 805 included in the information 800 represented by the two-dimensional code may be determined.

The operation of the printing system 100 will now be continued with reference again to FIG. 7A. In a case where it is determined to continue the printing processing in S708, in S709, the read application 323 sends a request for a print job to the data management unit 333 of the printing management server 103. This request includes the job identifier 801 included in the information 800 represented by the two-dimensional code. In S710, the data management unit 333 reads out, from the print job management table, the print job data associated with the job identifier included in the request from the printing apparatus 102 and responds to the printing apparatus 102 with this print job data. In this manner, the printing apparatus 102 obtains a print job from the printing management server 103 (executes job obtainment).

In S711, the read application 323 sends the print job data received from the printing management server 103 to the print application 324 and requests that printing be performed according to the print job data. In S712, the print application 313 performs printing according to the print job data and transmits the printing result to the read application 323. The read application 323 may transmit the printing result to the mobile device 101.

In a case where it is determined to suspend the printing processing in S708, in S713, the read application 323 suspends the printing processing. In a case where it is determined that “Display warning” is specified in the behavior settings 805 included in the information 800 represented by the two-dimensional code, the read application 323 notifies the user that the printing processing has been suspended. This notification may be performed using the operation unit 231 of the printing apparatus 102 or using the display unit 210 of the mobile device 101. In a case where it is determined that “Suspend printing” is specified in the behavior settings 805 included in the information 800 represented by the two-dimensional code, the read application 323 may not notify the user that the printing processing has been suspended.

In a case where it is determined to confirm with the user whether or not to continue the printing processing in S708, the read application 323 asks the user whether or not they will continue the printing processing. Asking the user may be performed by displaying a confirmation dialog on the operation unit 231 of the printing apparatus 102. Alternatively, asking the user may be performed by displaying a confirmation dialog on the display unit 210 of the mobile device 101.

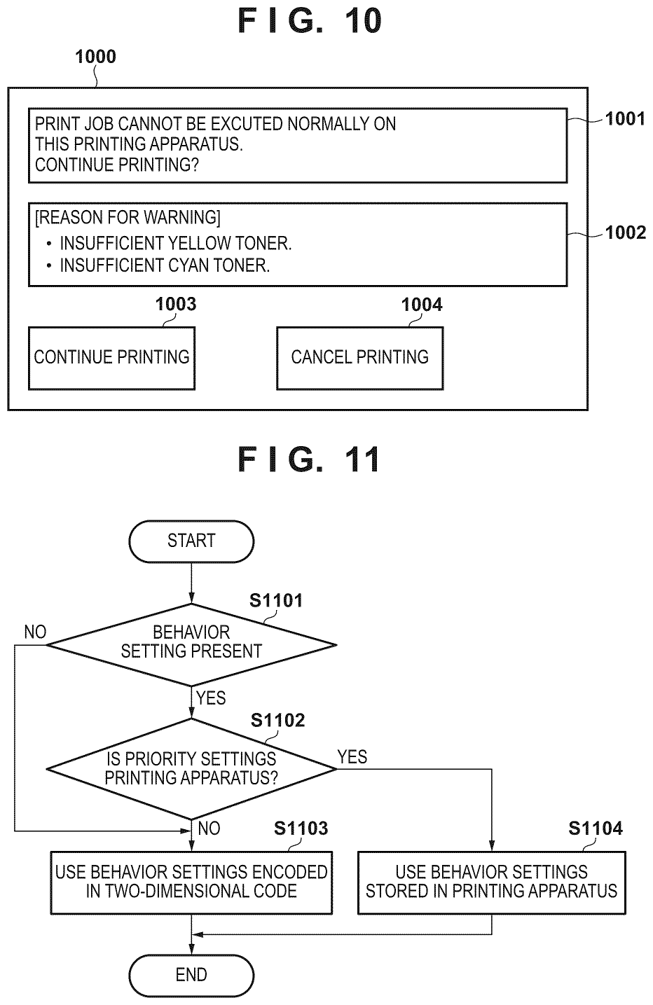

An example of a confirmation dialog 1000 for asking the user whether or not they will continue the printing processing will be described with reference to FIG. 10. The confirmation dialog 1000 may include a warning message 1001, a warning reason 1002, a continue printing button 1003, and a cancel printing button 1004.

The warning message 1001 notifies the user who has started the printing processing using the two-dimensional code that the printing processing cannot be normally completed. The warning reason 1002 describes to the user who has started the printing processing using the two-dimensional code a detailed reason (in other words, why the printing apparatus 102 does not satisfy the completion condition) as to why the printing processing cannot be normally completed. The continue printing button 1003 is a button for the user to issue an instruction to continue printing to the read application 323 of the printing apparatus 102. The cancel printing button 1004 is a button for the user to issue an instruction to cancel printing to the read application 323 of the printing apparatus 102. The confirmation dialog 1000 can obtain an instruction from the user via the continue printing button 1003 and the cancel printing button 1004.

A case of a confirmation dialog being displayed by the display unit 210 of the mobile device 101 will now be described with reference again to FIG. 7B. This operation may be different depending on whether or not the mobile device 101 and the printing apparatus 102 can connect to one another.

In S714, the read application 323 determines whether or not the printing apparatus 102 can connect to the mobile device 101. In a case where the registration processing described using FIG. 5 has already been executed, the printing apparatus 102 may be able to connect to the mobile device 101. In a case where it is determined that the printing apparatus 102 can connect to the mobile device 101 in S714, the processing transitions to S715.

In S715, the read application 323 sends a request to the print application 313 of the mobile device 101 to display the confirmation dialog 1000. This request may include a detailed reason as to why the printing processing cannot be normally completed. The print application 313 generates the confirmation dialog 1000 including the warning reason included in the request from the read application 323 and displays the confirmation dialog 1000 on the display unit 210. Instead of the print application 313 generating the confirmation dialog 1000, the read application 323 may generate the confirmation dialog 1000 and may transmit the confirmation dialog 1000 to the print application 313.

In S716, the print application 313 transmits the user selection result relating to whether or not to continue the printing processing to the read application 323. In response to a user pressing the continue printing button 1003, the print application 313 notifies the read application 323 that the user has selected to continue the printing processing. In this case, the printing system 100 continues the printing processing and executes the same processing as in S709 to S712. In response to a user pressing the cancel printing button 1004, the print application 313 notifies the read application 323 that the user has selected to cancel the printing processing. In this case, the read application 323 cancels the printing processing.

In a case where it is determined that the printing apparatus 102 cannot connect to the mobile device 101 in S714, the processing transitions to S717. In S717, the read application 323 transmits a request to the data management unit 333 of the printing management server 103 to display the confirmation dialog 1000 on the mobile device 101. This request includes the information included in the warning reason 1002 of the confirmation dialog 1000 and the job identifier 801.

In S718, the data management unit 333 references the print job management table (Table 3) and identifies the mobile device 101 associated with the job identifier obtained from the printing apparatus 102. In S719, the data management unit 333 sends a request to the print application 313 of the mobile device 101 identified in S718 to display the confirmation dialog 1000. This request may include a detailed reason as to why the printing processing cannot be normally completed. The print application 313 generates the confirmation dialog 1000 including the warning reason included in the request from the read application 323 and displays the confirmation dialog 1000 on the display unit 210. Instead of the print application 313 generating the confirmation dialog 1000, the read application 323 or the data management unit 333 may generate the confirmation dialog 1000.

In S720, the print application 313 transmits the user selection result relating to whether or not to continue the printing processing to the data management unit 333. The data management unit 333 transfers this user selection result to the read application 323. In a case where the user has selected to continue the printing processing, the printing system 100 continue the printing processing and executes the same processing as in S709 to S712. In a case where the user has selected to cancel the printing processing, the read application 323 cancels the printing processing.

In this manner, according to the first embodiment, since a completion condition is encoded in the two-dimensional code, whether or not the printing apparatus 102 which read the two-dimensional code can complete the printing processing can be promptly determined (for example, before receiving a print job from the printing management server 103). Also, according to the first embodiment, since the behavior settings is also encoded in the two-dimensional barcode, the printing apparatus 102 can promptly execute the behavior designated by the user (for example, before receiving a print job from the printing management server 103).

### Second Embodiment

In the first embodiment, the behavior at time of insufficiency is determined on the basis of the behavior settings designated by the user. The second embodiment is different from the first embodiment in that the behavior at time of insufficiency is determined on the basis of the behavior settings designated by the user and the behavior settings stored in the printing apparatus 102. Hereinafter, redundant description of content similar to that of the first embodiment will be omitted.

In the second embodiment, in S708 of FIG. 7A, the read application 323 executes the operation of FIG. 11 before executing the operation of FIG. 9. In S1101, the read application 323 determines whether or not behavior information is included in a behavior information table managed by the settings management unit 325. In a case where it is determined that behavior information is included in the behavior information table (“YES” in S1101), the processing transitions to S1102. Otherwise (“NO” in S1101), the processing transitions to S1103. The behavior information table is stored in a storage apparatus (for example, either the ROM 222 or the HDD 224) of the printing apparatus 102. The behavior information table may be generated by the administrator of the printing apparatus 102 and stored in a storage apparatus of the printing apparatus 102. Table 7 below is an example of a behavior information table managed by the settings management unit 325.

TABLE 7

| Behavior | Priority |
|---|---|
| settings | settings |
| Confirm | Printing |
| warning | apparatus |

The “Behavior settings” column stores the behavior at time of insufficiency. As with the designation in the behavior settings portion 442, the “Behavior settings” column may be selectable from “Suspend printing”, “Continue printing”, “Display warning”, “Confirm warning”, and the like. The “Priority settings” stores whether to use the behavior settings stored in the storage apparatus of the printing apparatus 102 (in other words, the behavior settings stored in the “Behavior settings” column) or the behavior settings encoded in the two-dimensional code.

In S1102, the read application 323 determines whether or not the value of the “Priority settings” column is “Printing apparatus”. In a case where it is determined that the value of the “Priority settings” column is “Printing apparatus” (“YES” in S1102), the processing transitions to S1104. Otherwise (“NO” in S1102), the processing transitions to S1103. For example, in a case where the value of the “Priority settings” column is “Two-dimensional code”, the processing may transition to S1103.

In S1103, the read application 323 determines to use the behavior settings encoded in the two-dimensional code read in S705. In this case, in the subsequent processing, the behavior settings encoded in the two-dimensional code read in S705 is used. In S1104, the read application 323 determines to use the behavior settings stored in the storage apparatus of the printing apparatus 102. In this case, in the subsequent processing, the behavior settings read out from the storage apparatus of the printing apparatus 102 are used.

According to the second embodiment, in accordance with the settings of the “Priority settings” column, either the behavior settings encoded in the two-dimensional code or the behavior settings stored in the storage apparatus of the printing apparatus 102 is obtained. The printing apparatus 102 executes the behavior at time of insufficiency according to the behavior settings. Accordingly, the administrator of the printing apparatus 102 can designate the behavior at time of insufficiency regardless of the behavior settings encoded in the two-dimensional code.

In the second embodiment, the behavior settings may not be encoded in the two-dimensional code. In this case, the printing apparatus 102 may always use the behavior settings stored in the storage apparatus of the printing apparatus 102.

### Third Embodiment

In the first embodiment, the behavior at time of insufficiency is determined on the basis of the behavior settings designated by the user. The third embodiment is different from the first embodiment in that the behavior at time of insufficiency is determined on the basis of the behavior settings designated by the user and the behavior settings stored in the printing management server 103. Hereinafter, redundant description of content similar to that of the first embodiment will be omitted.

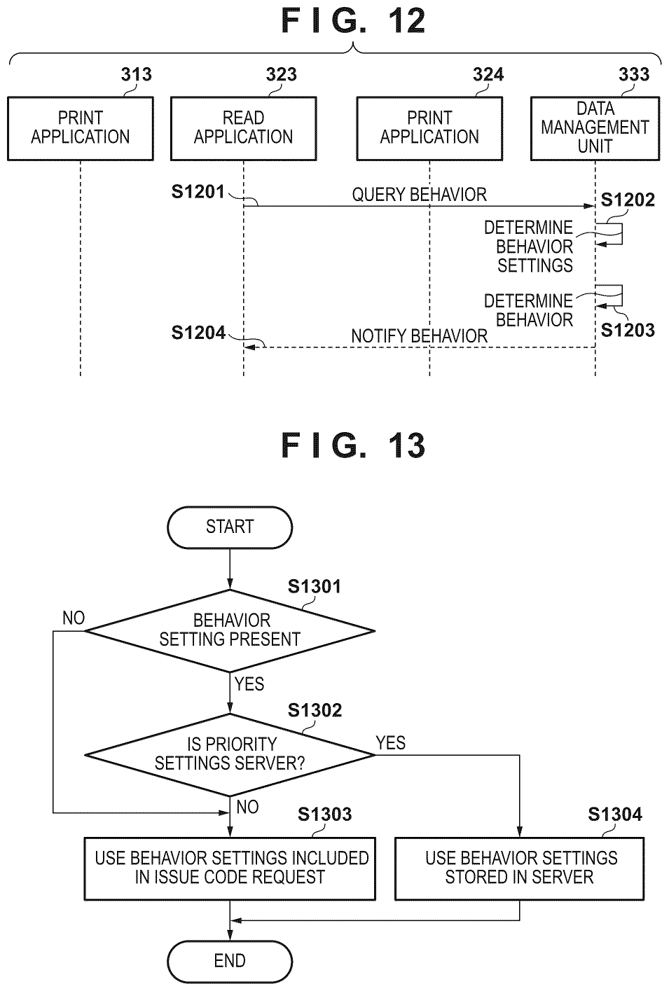

In the third embodiment, instead of S708 of FIG. 7A, S1201 to S1204 of FIG. 12 is executed. In S1201, the read application 323 of the printing apparatus 102 queries the printing management server 103 for the behavior at time of insufficiency to be executed by the printing apparatus 102. This query may include information used for determining whether or not the printing apparatus 102 satisfies the completion condition, for example, the function information obtained in S706 and the consumable information obtained in S707.

In S1202, the data management unit 333 of the printing management server 103 determines whether the printing apparatus 102 should execute the behavior specified by the behavior settings included in the issue code request or the behavior settings stored in the printing management server 103. The processing of S1202 will now be described in detail with reference to FIG. 13.

In S1301, the data management unit 333 determines whether or not behavior information is included in the behavior information table managed by the data management unit 333. In a case where it is determined that behavior information is included in the behavior information table (“YES” in S1301), the processing transitions to S1302. Otherwise (“NO” in S1301), the processing transitions to S1303. The behavior information table is stored in a storage apparatus (for example, either the RAM 223 or the HDD 224) of the printing management server 103. The behavior information table may be generated by the administrator of the printing management server 103 and stored in a storage apparatus of the printing management server 103. Table 8 below is an example of a behavior information table managed by the data management unit 333.

TABLE 8

| Behavior | Priority |
|---|---|
| settings | settings |
| Confirm | Printing |
| warning | management |
| | server |

The “Behavior settings” column stores the behavior at time of insufficiency. As with the designation in the behavior settings portion 442, the “Behavior settings” column may be selectable from “Suspend printing”, “Continue printing”, “Display warning”, “Confirm warning”, and the like. The “Priority settings” stores whether to use the behavior settings stored in the storage apparatus of the printing management server 103 (in other words, the behavior settings stored in the “Behavior settings” column) or the behavior settings included in the issue code request.

In S1302, the data management unit 333 determines whether or not the value of the “Priority settings” column is “Printing management server”. In a case where it is determined that the value of the “Priority settings” column is “Printing management server” (“YES” in S1302), the processing transitions to S1304. Otherwise (“NO” in S1302), the processing transitions to S1303. For example, in a case where the value of the “Priority settings” column is “Two-dimensional code”, the processing may transition to S1303.

In S1303, the data management unit 333 determines to use the behavior settings included in the issue code request. In this case, in the subsequent processing, the behavior settings included in the issue code request are used. In S1304, the data management unit 333 determines to use the behavior settings stored in the storage apparatus of the printing management server 103. In this case, in the subsequent processing, the behavior settings read out from the storage apparatus of the printing management server 103 are used.

Returning to the description of FIG. 12, in S1203, the data management unit 333 determines the behavior to be executed by the printing apparatus 102 as in S708. In this determination, the behavior settings selected in S1202 are used. In S1204, the data management unit 333 notifies the printing apparatus 102 of the determined behavior. The printing apparatus 102 executes the subsequent processing according to the notified behavior.

According to the third embodiment, the administrator of the printing management server 103 can designate the behavior at time of insufficiency regardless of the behavior settings included in the issue code request.

In the third embodiment, the behavior settings may not be encoded in the two-dimensional code. In this case, the printing apparatus 102 may always execute the behavior determined by the printing management server 103.

### Fourth Embodiment

The fourth embodiment is different from the first embodiment in that whether or not a printing apparatus that the mobile device 101 can connect to satisfies the completion condition is further displayed. Hereinafter, redundant description of content similar to that of the first embodiment will be omitted. The difference between the first embodiment and the fourth embodiment may also be applied to the second embodiment and the third embodiment.

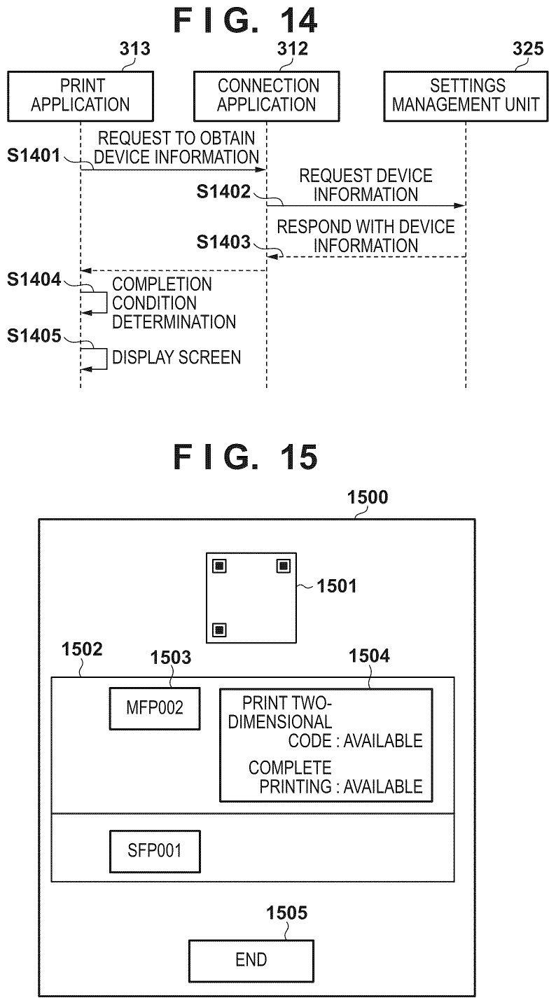

In the fourth embodiment, instead of S701 of FIG. 7A, S1401 to S1404 of FIG. 14 are executed. In S1401, the print application 313 of the mobile device 101 sends a request to the connection application 312 to obtain the device information of one or more printing apparatuses 102 that can connect to the mobile device 101. In S1402, the connection application 312 sends a request for the device information to the one or more printing apparatuses 102 that can connect to the mobile device 101 via the network 104. The one or more printing apparatuses 102 that can connect to the mobile device 101 may be the printing apparatus 102 which is “OK” in the “Communication status” column from among the device information registered in the device table (Table 1) of the data management unit 314.

In S1403, each of the one or more printing apparatuses 102 that received a request in S1402 responds to the mobile device 101 with their own device information. The device information may include the function information and the consumable information described above. The connection application 312 sends the device information received from the one or more printing apparatuses 102 to the print application 313.

In S1404, as in S901 and S902, the print application 313 determines whether or not each of the one or more printing apparatuses 102 satisfies the completion condition on the basis of the received device information. In S1405, the print application 313 displays, on the display unit 210, a two-dimensional code display screen 1500 including the two-dimensional code obtained from the printing management server 103 and information indicating whether or not each of the one or more printing apparatuses that the mobile device 101 can connect to satisfies the completion condition.

An example of the two-dimensional code display screen 1500 will now be described with reference to FIG. 15. In the fourth embodiment, instead of the two-dimensional code display screen 450, the two-dimensional code display screen 1500 is displayed. A two-dimensional code display portion 1501 and an end button 1505 are similar to the two-dimensional code display portion 451 and the end button 452 of FIG. 4B.

A device list 1502 indicates the one or more printing apparatuses 102 that the mobile device 101 can communicate with. A device name label 1503 displays the device names of the printing apparatuses 102. A status label 1504 displays the determination result of S1404. The status label 1504 is not displayed except for device information in which the value of the “Communication status” of the device table is “OK” at the point in time when the sequence illustrated in FIG. 14 is executed.

In the fourth embodiment, which printing apparatuses 102 satisfy the completion condition is displayed on the mobile device 101. Thus, the user can appropriately select the printing apparatus to execute the printing processing using the two-dimensional.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-130531, filed Aug. 9, 2023, which is hereby incorporated by reference herein in its entirety.

What is claimed is:

1. A printing apparatus comprising:
a reading unit that reads a two-dimensional code including an encoded completion condition for the printing apparatus to satisfy in order to complete printing processing according to a print job stored in a printing management server and an encoded identifier of the print job;
a settings obtaining unit that obtains behavior settings specifying a behavior of the printing apparatus for a case where it is determined that the printing apparatus does not satisfy the completion condition; and
an executing unit that executes a behavior specified by the behavior settings in a case where it is determined that the printing apparatus does not satisfy the completion condition.

2. The printing apparatus according to claim 1, wherein
the behavior settings specify continuing the printing processing, suspending the printing processing, or asking a user whether to continue the printing processing.

3. The printing apparatus according to claim 1, further comprising:
a job obtaining unit that obtains the print job from the printing management server in a case where it is determined that the printing apparatus satisfies the completion condition.

4. The printing apparatus according to claim 1, wherein
the behavior settings are also encoded in the two-dimensional code, and
the settings obtaining unit obtains the behavior settings from the two-dimensional code.

5. The printing apparatus according to claim 1, further comprising:
a storing unit that stores the behavior settings, wherein
the settings obtaining unit obtains the behavior settings from the storing unit.

6. The printing apparatus according to claim 1, wherein
first behavior settings are also encoded in the two-dimensional code,
the printing apparatus further includes a storing unit that stores second behavior settings,
the settings obtaining unit obtains the first behavior settings or the second behavior settings according to settings, and
the executing unit executes behavior specified by the first behavior settings or the second behavior settings obtained by the settings obtaining unit in a case where it is determined that the printing apparatus does not satisfy the completion condition.

7. The printing apparatus according to claim 1, wherein
the completion condition includes at least one of
a condition relating to an amount of a consumable necessary for completing the printing processing, and
a condition relating to a function necessary for completing the printing processing.

8. The printing apparatus according to claim 1, wherein
the executing unit suspends the printing processing in a case where an error occurs in the printing apparatus when the reading unit reads the two-dimensional code.

9. A method for controlling a printing apparatus, the method comprising:
reading a two-dimensional code including an encoded completion condition for the printing apparatus to satisfy in order to complete printing processing according to a print job stored in a printing management server and an encoded identifier of the print job;
obtaining behavior settings specifying a behavior of the printing apparatus for a case where it is determined that the printing apparatus does not satisfy the completion condition; and
executing a behavior specified by the behavior settings in a case where it is determined that the printing apparatus does not satisfy the completion condition.

10. A mobile device comprising:
an obtaining unit that obtains, from a user, a designation of target print data of printing processing, a designation of print settings for the printing processing, and a designation of behavior settings specifying a behavior of a printing apparatus for a case where it is determined that the printing apparatus does not satisfy a completion condition to be satisfied in order to complete the printing processing;
a transmitting unit that transmits an issue code request, the issue code request including the print data, the print settings, and the behavior settings to a printing management server;
a receiving unit that receives, from the printing management server, a two-dimensional code including an encoded completion condition and an encoded identifier of a print job relating to the printing processing as a response to the issue code request; and
a display unit that displays the two-dimensional code.

11. The mobile device according to claim 10, wherein
the display unit further displays a dialog in response to a request from the printing management server or the printing apparatus, and
the dialog is configured to obtain from the user an instruction to continue the printing processing and an instruction to cancel the printing processing.

12. The mobile device according to claim 11, wherein
the dialog includes a reason that the printing apparatus does not satisfy the completion condition.

13. The mobile device according to claim 10, wherein
the display unit displays a screen including the two-dimensional code and information indicating whether a printing apparatus that the mobile device can connect to satisfies the completion condition.

14. A method for controlling a mobile device, the method comprising:
obtaining, from a user, a designation of target print data of printing processing, a designation of print settings for the printing processing, and a designation of behavior settings specifying a behavior of a printing apparatus for a case where it is determined that the printing apparatus does not satisfy a completion condition to be satisfied in order to complete the printing processing;
transmitting an issue code request, the issue code request including the print data, the print settings, and the behavior settings to a printing management server;
receiving, from the printing management server, a two-dimensional code including an encoded completion condition and an encoded identifier of a print job relating to the printing processing as a response to the issue code request; and
displaying the two-dimensional code.

15. A non-transitory computer readable storage medium that stores a program for causing a computer to function as each unit of the mobile device according to claim 10.

16. A printing management server comprising:
a receiving unit that receives, from a mobile device, an issue code request, the issue code request including target print data of printing processing, print settings for the printing processing, and behavior settings specifying a behavior of a printing apparatus for a case where it is determined that the printing apparatus does not satisfy a completion condition to be satisfied in order to complete the printing processing;
a generating unit that generates a two-dimensional code including an encoded completion condition and an encoded identifier of a print job relating to the printing processing; and
a transmitting unit that transmits the two-dimensional code to the mobile device.

17. The printing management server according to claim 16, wherein
the behavior settings include first behavior settings, and
the printing management server further includes
a storing unit that stores second behavior settings, and
a determining unit that determines whether the printing apparatus is to execute a behavior specified in the first behavior settings or the second behavior settings.

18. A method for controlling a printing management server, the method comprising:
receiving, from a mobile device, an issue code request, the issue code request including target print data of printing processing, print settings for the printing processing, and behavior settings specifying a behavior of a printing apparatus for a case where it is determined that the printing apparatus does not satisfy a completion condition to be satisfied in order to complete the printing processing;
generating a two-dimensional code including an encoded completion condition and an encoded identifier of a print job relating to the printing processing; and
transmitting the two-dimensional code to the mobile device.
